(19) United States
(12) Patent Application Publication
(10) Pub. No.: US 2010/0040115 A1
(43) Pub. Date: Feb. 18, 2010

(54) APPARATUS FOR ACQUIRING REFINE CARRIER FREQUENCY BY OPTIMIZING SEARCH AREAS AND METHOD USING THE SAME

(75) Inventors: Young-Su Cho, Seoul (KR); Byung-Doo Kim, Daejeon-city (KR); Seong-Yun Cho, Daejeon-city (KR); Wan-Sik Choi, Daejeon-city (KR); Jong-Hyun Park, Daejeon-city (KR)

Correspondence Address: Muncy, Geissler, Olds & Lowe, PLLC, P.O. BOX 1364, FAIRFAX, VA, 22038-1364, US

(73) Assignee: ELECTRONICS AND TELECOMMUNICATIONS RESEARCH INSTITUTE, Dajeon-city (KR)

(21) Appl. No.: 12/514,807

(22) PCT Filed: Nov. 14, 2007
(86) PCT No.: PCT/KR07/05717

§ 371 Date: May 14, 2009

(30) Foreign Application Priority Data
Nov. 15, 2006 (KR) 10-2006-0113055
Mar. 28, 2007 (KR) 10-2007-0030351

(51) Int. Cl. H04B 1/00

(52) U.S. Cl. 375/145

(57) ABSTRACT

A method and apparatus for acquiring a refined carrier frequency by optimizing search areas are provided. The apparatus for acquiring a refined carrier frequency by optimizing search areas includes: a refined signal generation unit using a coarse carrier frequency and a coarse code phase extracted from a digitized signal and obtaining a refined carrier frequency approximated to the carrier frequency of an original signal from which the digitized signal is obtained by conversion; and a refined carrier frequency searching unit setting and providing a search area in which the refined signal acquisition unit can obtain the refined carrier frequency based on the coarse carrier frequency. According to the method and apparatus, as a result of the searching method reducing a search time, acquisition of a refined carrier frequency as well as fast acquisition of a signal is enabled, thereby allowing a precise initial value to be provided to a signal tracking unit.

### TECHNICAL FIELD

The present invention relates to a method of acquiring a refined carrier frequency by optimizing search areas in order to implement an optimum performance of a signal tracking loop in a global navigation satellite system (GNSS) receiver and an apparatus using the method, and more particularly, to a method of efficiently calculating and acquiring a refined carrier frequency from a coarse code phase and a coarse carrier frequency calculated by performing a coarse signal acquisition process in a GNSS receiver, and an apparatus using the method.

### BACKGROUND ART

A conventional technique for acquiring a global navigation satellite system (GNSS) signal is broken down into coarse signal acquisition and refined signal acquisition.

The coarse signal acquisition is a process in which visible GNSS satellites are determined and the carrier frequency and code phase of the satellite are roughly determined. Representative methods of acquiring a coarse signal include serial search acquisition and parallel code phase search acquisition. The serial search acquisition can selectively determine a search area and a search precision of a carrier frequency, but has a disadvantage in that the calculation time increases. The parallel code phase search acquisition utilizes fast Fourier transformation (FFT), thereby reducing the calculation time, but the degree to which the precision of the carrier frequency can be increased is limited.

The refined signal acquisition is a process for increasing the degree of precision of the approximate carrier frequency calculated through the coarse signal acquisition. In general, the degree of precision of the carrier frequency calculated in the coarse signal acquisition is too low to be used as an initial value of a signal tracking loop, and a process of making the carrier frequency more precise is required. Conventional methods of acquiring a refined frequency include a method of mixing the parallel code phase search acquisition and the serial search acquisition, and an analytical frequency refinement method using the shape of a correlation waveform.

When the two methods are compared with each other, the method of mixing the parallel code phase search acquisition and the serial search acquisition has a relatively longer calculation time in order to obtain a degree of precision of the frequency in a range of tens of Hz, compared to the analytical frequency refinement method. Accordingly, in order to apply the method of mixing the parallel code phase search method and the serial search method to a GNSS receiver, a method of acquiring a signal through reduction of a calculation time is required, and a variety of research has been carried out into means of quickly acquiring a signal in a GNSS receiver.

### DETAILED DESCRIPTION OF THE INVENTION

### Technical Problem

The present invention provides a method of improving the performance of acquiring a signal in a global navigation satellite system (GNSS) receiver, by optimizing search areas and reducing a time for acquiring a signal when a refined carrier frequency is acquired, and an apparatus using the method.

### Technical Solution

According to an aspect of the present invention, there is provided an apparatus for acquiring a refined carrier frequency by optimizing search areas, the apparatus including: a refined signal generation unit using a coarse carrier frequency and a coarse code phase extracted from a digitized signal and obtaining a refined carrier frequency approximated to the carrier frequency of an original signal from which the digitized signal is obtained by conversion; and a refined carrier frequency searching unit setting and providing a search area in which the refined signal acquisition unit can obtain the refined carrier frequency based on the coarse carrier frequency.

According to another aspect of the present invention, there is provided a method of acquiring a refined carrier frequency by optimizing search areas, the method including: based on a coarse carrier frequency and a coarse code phase extracted from a digitized global navigation satellite system (GNSS) signal, obtaining a refined carrier frequency approximated to the carrier frequency of an intermediate frequency signal from which the digitized signal is obtained by conversion; and setting a search area in which the refined carrier frequency can be obtained.

### ADVANTAGEOUS EFFECTS

According to the apparatus and method, as a result of the searching method reducing a search time, acquisition of a refined carrier frequency as well as fast acquisition of a signal is enabled, thereby allowing a precise initial value to be provided to a signal tracking unit.

Also, by reducing the calculation time required in a signal acquisition process, the present invention can be used in a signal acquisition process using algorithms for conventional global navigation satellite system (GNSS) receivers, GNSS System In Package (SIP) chips, GNSS baseband chips, and GNSS software receivers which should enhance efficiency in terms of the amount of computation and the time it takes.

### DESCRIPTION OF THE DRAWINGS

FIG. 1 is a block diagram illustrating a structure of a global navigation satellite system (GNSS) receiver device including an apparatus for acquiring a refined carrier frequency by optimizing search areas, according to an embodiment of the present invention;

FIG. 2 is a block diagram illustrating a structure of a coarse signal acquiring unit according to conventional technology;

FIG. 3A is a block diagram illustrating a structure of an apparatus for acquiring a refined carrier frequency by optimizing search areas, according to an embodiment of the present invention;

FIG. 3B is a detailed block diagram of the structure illustrated in FIG. 3A, according to an embodiment of the present invention;

FIG. 4 is a diagram illustrating an apparatus for searching for a refined frequency by using serial approximation, according to conventional technology;

FIG. 5 is a diagram illustrating an apparatus for acquiring a refined carrier frequency using successive approximation, according to an embodiment of the present invention;

FIG. 6 is a diagram illustrating an apparatus for acquiring a refined carrier frequency using median successive approximation, according to an embodiment of the present invention;

FIG. 7 is a table comparing performances of when serial approximation, successive approximation, and media successive approximation are used according to an embodiment of the present invention; and

FIG. 8 is a flowchart illustrating a method of acquiring a refined carrier frequency by optimizing search areas, according to an embodiment of the present invention.

### BEST MODE

According to an aspect of the present invention, there is provided an apparatus for acquiring a refined carrier frequency by optimizing search areas, the apparatus including: a refined signal generation unit using a coarse carrier frequency and a coarse code phase extracted from a digitized signal and obtaining a refined carrier frequency approximated to the carrier frequency of an original signal from which the digitized signal is obtained by conversion; and a refined carrier frequency searching unit setting and providing a search area in which the refined signal acquisition unit can obtain the refined carrier frequency based on the coarse carrier frequency.

According to another aspect of the present invention, there is provided a method of acquiring a refined carrier frequency by optimizing search areas, the method including: based on a coarse carrier frequency and a coarse code phase extracted from a digitized global navigation satellite system (GNSS) signal, obtaining a refined carrier frequency approximated to the carrier frequency of an intermediate frequency signal from which the digitized signal is obtained by conversion; and setting a search area in which the refined carrier frequency can be obtained.

### Mode of the Invention

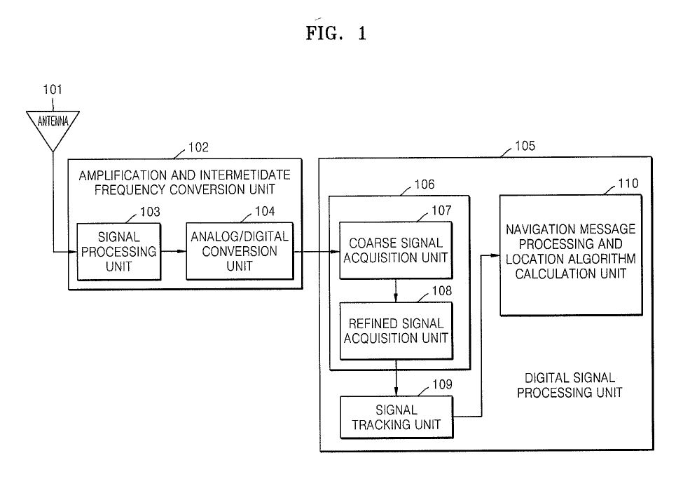

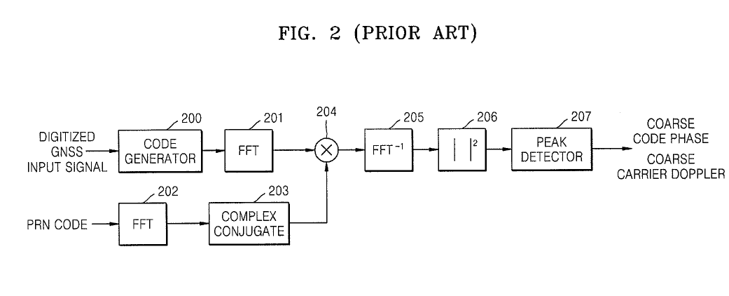

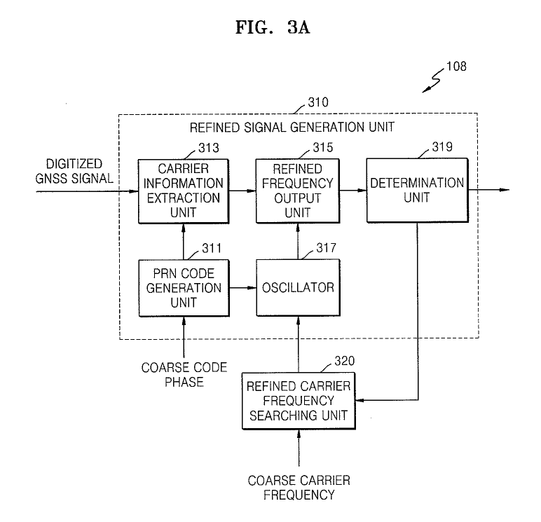

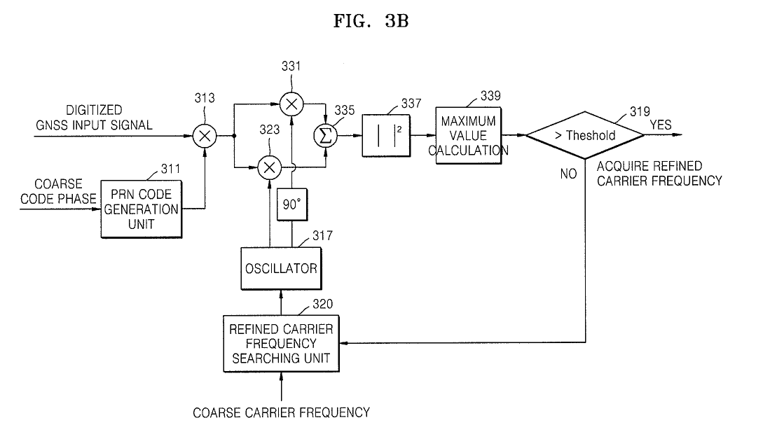

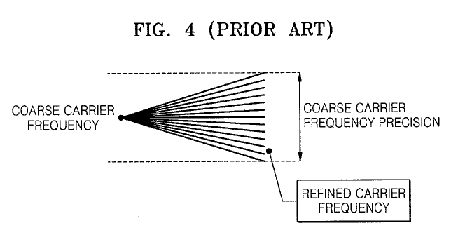

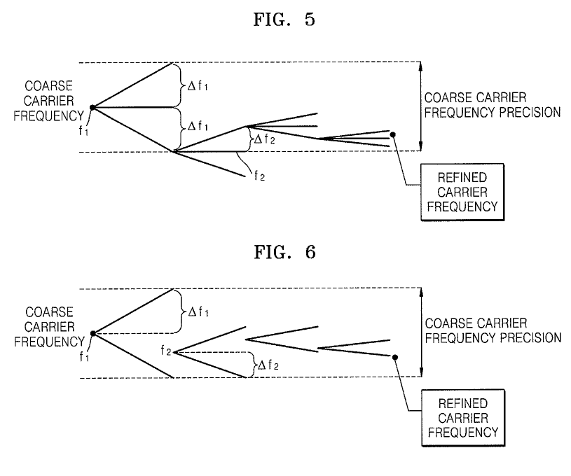

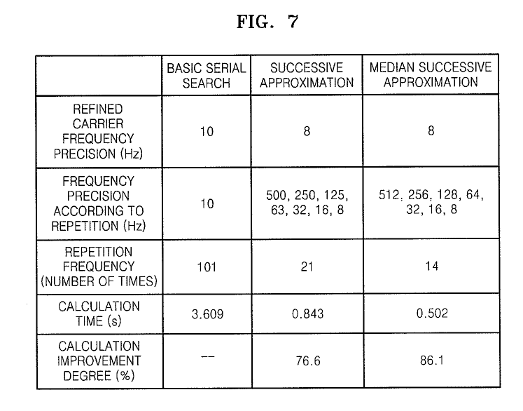

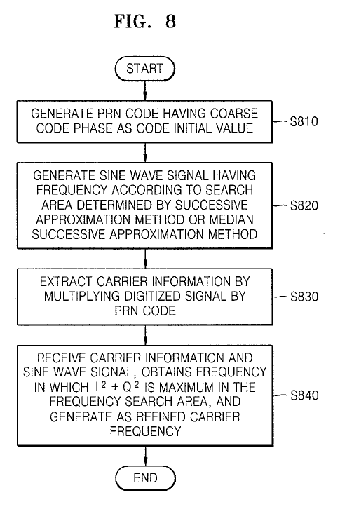

FIG. 1 is a block diagram illustrating a structure of a global navigation satellite system (GNSS) receiver device including an apparatus for acquiring a refined carrier frequency by optimizing search areas, according to an embodiment of the present invention, and FIG. 2 is a block diagram illustrating a structure of a coarse signal acquiring unit according to conventional technology. FIG. 3A is a block diagram illustrating a structure of an apparatus for acquiring a refined carrier frequency by optimizing search areas, according to an embodiment of the present invention, and FIG. 3B is a detailed block diagram of the structure illustrated in FIG. 3A, according to an embodiment of the present invention. FIG. 4 is a diagram illustrating an apparatus for searching for a refined frequency using serial approximation, according to conventional technology, and FIG. 5 is a diagram illustrating an apparatus for acquiring a refined carrier frequency using successive approximation, according to an embodiment of the present invention. FIG. 6 is a diagram illustrating an apparatus for acquiring a refined carrier frequency by using median successive approximation, according to an embodiment of the present invention, and FIG. 7 is a table comparing performances of when serial approximation, successive approximation, and media successive approximation illustrated in FIGS. 4 through 6 are used according to an embodiment of the present invention. Finally, FIG. 8 is a flowchart illustrating a method of acquiring a refined carrier frequency by optimizing search areas according to an embodiment of the present invention.

First, referring to FIG. 1, a GNSS receiver device for acquiring a refined carrier frequency by optimizing search areas, according to an embodiment of the present invention, broadly includes an antenna 101, an amplification and intermediate frequency conversion unit 102, and a digital signal processing unit 105.

The antenna 101 receives a signal from a GNSS satellite.

The amplification and intermediate frequency conversion unit 102 is formed by a signal processing unit 103 and an analog/digital conversion unit 104. The signal processing unit 103 amplifies the received GNSS signal to a signal that is strong enough for analog-to-digital conversion, and limits a noise bandwidth. The analog/digital conversion unit 104 digitizes the processed signal according to predetermined bits and a predetermined sampling frequency.

The digital signal processing unit 105 is formed by a signal acquisition unit 106, a signal tracking unit 109, and a navigation message processing and location algorithm calculation unit 110. The signal acquisition unit 106 calculates the carrier frequency and code phase of the GNSS signal digitized in the analog/digital conversion unit 104. The signal tracking unit 109 tracks how a carrier frequency and a code phase change over time, by using the carrier frequency and code phase calculated in the signal acquisition unit 106 as initial values of a signal tracking loop. The navigation message processing and location algorithm calculation unit 110 extracts a navigation message from the acquired code, and calculates the measured values of phase orbital information, a pseudo distance, a carrier phase, and the like.

The signal acquisition unit 106 is formed by a coarse signal acquisition unit 107 and a refined signal acquisition unit 108. The coarse signal acquisition unit 107 calculates a coarse carrier phase and a coarse code phase by using a fast Fourier transform (FFT) algorithm. The coarse signal acquisition unit 107 will now be explained in detail with reference to FIG. 2.

FIG. 2 is a block diagram illustrating an example in which a coarse carrier frequency and a coarse code phase are calculated by using an FFT algorithm in the coarse signal acquisition unit 107 according to conventional technology. As illustrated in FIG. 2, first, a code generator 200 multiplies each of a group of n intermediate frequency candidates (IF frequency bin: usually, by considering the intermediate frequency changes of an input signal by Doppler effect, a candidate group is selected by dividing the input signal into intervals within ±10 kHz. For example, if an IF input signal of 1 ms is input, the frequency resolution is 500 Hz, and therefore 41 IF frequency bins are generated in the range within ±10 kHz) by e^{j}*^{2πf}^{ᵢ}^{k} (i=1, 2, through to n, k=1, 2, through to m, n: the number of IF candidates, m: the number of data items according to a sampling frequency of an input signal). By doing so, the code generator 200 removes the carrier part of the input signal and then, generates and outputs only a code. Then, FFT 201 is performed, thereby transforming the signal from the time domain to the frequency domain. A pseudorandom number (PRN) code is also generated in relation to a corresponding satellite and converted into the frequency domain in FFT 202, and a complex conjugate 203 is obtained. Next, multiplication 204 of the FFT output of the input signal by the generated PRN code is performed. Then, inverse FFT 205 is performed, and the signal is transformed back into the time domain. This transformed value forms an n×m matrix, and the square 206 of the magnitude of each matrix element is obtained, and a peak value is detected in a peak detector 207. In this way, the locations of a row and a column allowing a time domain output value to have a maximum value can be finally calculated. In this case, a coarse code phase of the corresponding satellite is calculated from the location of a row and a coarse carrier frequency of the corresponding satellite is calculated from the location of a column. The process illustrated in FIG. 2 is performed for all GNSS satellites.

FIG. 3A is a block diagram illustrating a structure of an apparatus for acquiring a refined carrier frequency by optimizing search areas according to an embodiment of the present invention, and FIG. 8 is a flowchart illustrating a process of a method of acquiring a refined carrier frequency by optimizing search areas according to an embodiment of the present invention. The apparatus for acquiring a refined carrier frequency illustrated in FIG. 3A performs required functions in the refined signal acquisition unit 108 illustrated in FIG. 1. For this, the apparatus comprises a refined signal generation unit 310 obtaining a refined carrier frequency approximated to the carrier frequency of an intermediate frequency signal which is the original signal which the analog/digital conversion unit 104 digitizes into a digitized signal, and a refined carrier frequency searching unit 320 setting and providing a search area in which the refined signal generation unit 310 can obtain the refined carrier frequency based on the coarse carrier frequency.

The elements of the refined signal generation unit 310 will now be explained in more detail. A PRN code generation unit 311 generates and outputs a PRN code having a coarse code phase as a code initial value in operation S810. An oscillator 317 generates and outputs a sine wave signal having a frequency according to a search area provided by the refined carrier frequency searching unit 320 in operation S820. A process of controlling an output signal of an oscillator by setting a search area in this case will be explained later with reference to FIGS. 4 through 6. A carrier information extraction unit 313 performs a calculation having the digitized signal and the PRN code as inputs, and extracts carrier information of the original GNSS input signal in operation S830.

A refined frequency output unit 315 receives the carrier information and the sine wave signal, obtains a frequency in which the sum of the square of an in-phase component (I) and the square of an out-of-phase component (Q) is maximized in the frequency search area, and outputs the obtained frequency as the refined carrier frequency. The refined frequency output unit 315 operates in connection with a determination unit 319 which sets a determination criterion (for example, a threshold) for whether or not a value is a maximum value and determines whether or not the criterion is satisfied.

Referring to FIG. 3B, a more detailed embodiment of the structure illustrated in FIG. 3A will now be explained. As illustrated in FIG. 3B, first, a PRN code generation unit 311 generates a PRN code having a coarse code phase calculated in the coarse signal acquisition unit 107, as a code initial value. Then, if multiplication 313 of an input signal and the generated PRN code is performed, a code is removed from the input signal and only carrier information remains. The refined frequency output unit 315 illustrated in FIG. 3A may be implemented as blocks 331 through 339. That is, through control according to a frequency search area determined by the refined carrier frequency searching unit 320, a sine wave output from the oscillator 317 is mixed with the carrier information in operations 331 and 323, and then, the results are added in operation 335. Then, the square of the magnitude of a complex sample of an amplitude is obtained in operation 337 and a maximum value is calculated in operation 339. It is determined whether or not this maximum value is greater than a preset threshold in operation 319, and if it is greater than the preset threshold, the value is the refined carrier and therefore is output. If this maximum value is less than the preset threshold, the refined carrier frequency searching unit 320 is informed about the result, thereby adjusting the search area. In other words, in order to quickly find a refined frequency approximated to the carrier frequency of an input signal, a frequency search area is optimized through the refined carrier frequency searching unit 320, by using a coarse carrier frequency as an initial value. Then, from among searching frequencies set in this way, a frequency in which an output signal time-correlated with an input signal is maximized becomes a frequency approximated to the input signal, and until a desired degree of precision of a frequency is achieved, searching is repeatedly performed. Embodiments capable of reducing this repetitive searching time will now be explained in more detail with reference to FIGS. 4 through 6.

FIG. 4 is a diagram for explaining a refined carrier frequency searching operation by using conventional serial approximation in the refined signal acquisition unit 108. As illustrated in FIG. 4, taking a coarse carrier frequency calculated in the coarse signal acquisition unit 107 as a center, the degree of precision of a coarse carrier frequency is equally divided into refined frequency precision degrees. Then, by performing time correlation for each frequency, a frequency in which the sum (I²+Q²) of the square of an in-phase component (I) and the square of an out-of-phase component (Q) is maximized is determined as a refined carrier frequency. For example, if a coarse frequency precision degree is 1000 Hz and a refined frequency precision degree is 10 Hz, 100 search frequencies are generated.

FIG. 5 is a diagram for explaining an operation of the refined carrier frequency searching unit 320 using successive approximation in the refined carrier frequency acquisition apparatus illustrated in FIG. 3A. As illustrated in FIG. 5, three searching frequencies are selected with a coarse carrier frequency calculated in the coarse signal acquisition unit 107 as a center. In this case, assuming that the coarse carrier frequency is f₁, and a half of a coarse frequency precision degree is Δf₁, the three search frequencies are f₁, f₁+Δf₁, and f₁−Δf₁, respectively. Among these three frequencies, a frequency maximizing (I²+Q²) is determined as f₂, and Δf₂ is determined as round

$$( \frac{Δ {f}_{1}}{2} ) .$$

Here, round( ) means that a number in ( ) is rounded off. For example, it may mean that the first decimal place is rounded off so that the number can be an integer. This process is repeatedly performed by making Δf, which is set in continuous processes, i.e., Δfₙ which is continuously set, become round

$$( \frac{Δ {f}_{n - 1}}{2} ) ,$$

until Δfₙ becomes a desired refined carrier frequency area.

FIG. 6 is a diagram for explaining an operation of the refined carrier frequency searching unit 320 using median successive approximation in the refined carrier frequency acquisition apparatus illustrated in FIG. 3A. As illustrated in FIG. 6, two searching frequencies are selected with a coarse carrier frequency calculated in the coarse signal acquisition unit 107 as a center. In this case, assuming that the coarse carrier frequency is f₁, and a half of a coarse frequency precision degree is Δf₁, the two search frequencies are f₁+Δf₁, and f₁−Δf₁, respectively. Between these two frequencies, a frequency maximizing (I²+Q²) is determined as f₂, and Δf₂ is determined as round

$$( \frac{Δ {f}_{1}}{2} ) .$$

This process is repeatedly performed by making Δf, which is set in continuous processes, i.e., Δfₙ which is continuously set, become round

$$( \frac{Δ {f}_{n - 1}}{2} ) ,$$

until Δfₙ becomes a desired refined carrier frequency area.

FIG. 7 is a table comparing performances of when serial approximation, successive approximation, and media successive approximation, respectively, are applied according to embodiments of the present invention.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers of ordinary skill in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

### INDUSTRIAL APPLICABILITY

As described above, according to a method and apparatus for acquiring a refined carrier frequency by optimizing search areas according to the present invention, as a result of the searching method reducing a search time, acquisition of a refined carrier frequency as well as fast acquisition of a signal is enabled, thereby allowing a precise initial value to be provided to a signal tracking unit.

Also, by reducing the calculation time required in a signal acquisition process, the present invention can be used in a signal acquisition process using algorithms for conventional global navigation satellite system (GNSS) receivers, GNSS System In Package (SIP) chips, GNSS baseband chips, and GNSS software receivers which should enhance efficiency in terms of the amount of computation and the time it takes.

1. An apparatus for acquiring a refined carrier frequency by optimizing search areas, the apparatus comprising:
a refined signal generation unit, based on a coarse carrier frequency and a coarse code phase extracted from a digitized global navigation satellite system (GNSS) signal, obtaining a refined carrier frequency approximated to the carrier frequency of an intermediate frequency signal from which the digitized GNSS signal is obtained by conversion; and
a refined carrier frequency searching unit setting and providing a search area in which the refined signal acquisition unit can obtain the refined carrier frequency based on the coarse carrier frequency.

2. The apparatus of claim 1, wherein the refined signal generation unit comprises:
a pseudorandom number (PRN) code generation unit generating a PRN code having the coarse code phase as a PRN code initial value;
an oscillator generating a sine wave signal having a frequency according to the search area provided by the refined carrier frequency searching unit;
a carrier information extraction unit extracting carrier information by performing a predetermined calculation using the digitized GNSS signal and the PRN code; and
a refined frequency output unit receiving carrier information and the sine wave signal, obtaining a frequency in which a sum of the square of an in-phase component and the square of an out-of-phase component is maximized in the frequency search area, and outputting the frequency as the refined carrier frequency.

3. The apparatus of claim 2, wherein the carrier information extraction unit extracts the carrier information by multiplying the digitized GNSS signal by the PRN code.

4. The apparatus of claim 2, wherein the refined frequency output unit comprises a determination unit setting a threshold for determining whether or not the sum of the square is maximized.

5. The apparatus of claim 1, wherein the refined carrier frequency searching unit equally divides a degree of precision of a coarse carrier frequency into refined frequency precision degrees, taking the coarse carrier frequency as a center, and by performing time correlation for each frequency, the refined carrier frequency searching unit obtains a value maximizing I²+Q² (a sum of the square of an in-phase component and the square of an out-of-phase component) as a search area.

6. The apparatus of claim 1, wherein assuming that the coarse carrier frequency (f₁) is a center and a half of a coarse frequency precision degree is Δf₁, the refined carrier frequency searching unit sets three frequencies, f₁, f₁+Δf₁, and f₁−Δf₁, and from among the three frequencies, the refined carrier frequency searching unit determines a frequency maximizing I²+Q² (a sum of the square of an in-phase component and the square of an out-of-phase component) as f₂, and Δf₂ is determined as round
$$( \frac{Δ {f}_{1}}{2} ) ,$$
and by making Δfₙ which is continuously set, become round
$$( \frac{Δ {f}_{n - 1}}{2} ) ,$$
the search area is repeatedly obtained until Δfₙ becomes a desired refined carrier frequency area,
where round( ) means that a number in ( ) is rounded off.

7. The apparatus of claim 1, wherein assuming that the coarse carrier frequency (f₁) is a center and a half of a coarse frequency precision degree is Δf₁, the refined carrier frequency searching unit sets two frequencies, f₁+Δf₁, and f₁−Δf₁, and between the two frequencies, the refined carrier frequency searching unit determines a frequency maximizing I²+Q² (a sum of the square of an in-phase component and the square of an out-of-phase component) as f₂, and Δf₂ is determined as round
$$( \frac{Δ {f}_{1}}{2} ) ,$$
and by making Δfₙ which is continuously set, become round
$$( \frac{Δ {f}_{n - 1}}{2} ) ,$$
the search area is repeatedly obtained until Δfₙ becomes a desired refined carrier frequency area,
where round( ) means that a number in ( ) is rounded off.

8. A method of acquiring a refined carrier frequency by optimizing search areas, the method comprising:
based on a coarse carrier frequency and a coarse code phase extracted from a digitized GNSS signal, obtaining a refined carrier frequency approximated to the carrier frequency of an intermediate frequency signal from which the digitized GNSS signal is obtained by conversion; and
setting a search area in which the refined carrier frequency can be obtained.

9. The method of claim 8, wherein the obtaining of the refined carrier frequency comprises:
generating a PRN code having the coarse code phase as a PRN code initial value;
generating a sine wave signal having a frequency according to the search area;
extracting carrier information by multiplying the digitized GNSS signal and the PRN code; and
receiving the carrier information and the sine wave signal, obtaining a frequency in which a sum of the square of an in-phase component and the square of an out-of-phase component is maximized in the frequency search area, and outputting the frequency as the refined carrier frequency.

10. The method of claim 9, wherein in the outputting of the frequency as the refined carrier frequency, the generating of the PRN code, the sine wave signal, and the extracting of the carrier information are repeatedly performed until the sum of the squares exceeds a predetermined threshold.

11. The method of claim 8, wherein the setting of the search area comprises:
assuming that f₁ is a coarse carrier frequency and Δf₁ is a half of a coarse frequency precision degree, selecting three frequencies, f₁, f₁+Δf₁, and f₁−Δf₁;
from among the three frequencies, determining a frequency maximizing I²+Q² as f₂, and determining Δf₂ as round
$$( \frac{Δ {f}_{1}}{2} ) ;$$
and
by making Δfₙ which is continuously set, become round
$$( \frac{Δ {f}_{n - 1}}{2} ) ,$$
repeatedly generating the search area until Δfₙ becomes a desired refined carrier frequency area,
where round( ) means that a number in ( ) is rounded off.

12. The method of claim 8, wherein the setting of the search area comprises:
assuming that f₁ is a coarse carrier frequency and Δf₁ is a half of a coarse frequency precision degree, selecting two frequencies, f₁+Δf₁, and f₁−Δf₁;
between the two frequencies, determining a frequency maximizing I²+Q² as f₂, and determining Δf₂ as round
$$( \frac{Δ {f}_{1}}{2} ) ;$$
and
by making Δfₙ which is continuously set, become round
$$( \frac{Δ {f}_{n - 1}}{2} ) ,$$
repeatedly generating the search area until Δfₙ becomes a desired refined carrier frequency area,
where round( ) means that a number in ( ) is rounded off.

13. A computer readable recording medium having embodied thereon a computer program for executing a method of acquiring a refined carrier frequency by optimizing search areas, wherein the method comprises:
based on a coarse carrier frequency and a coarse code phase extracted from a digitized GNSS signal, obtaining a refined carrier frequency approximated to the carrier frequency of an intermediate frequency signal from which the digitized GNSS signal is obtained by conversion; and
setting a search area in which the refined carrier frequency can be obtained.
